(19) United States
(12) Patent Application Publication
(10) Pub. No.: US 2023/0391355 A1
(43) Pub. Date: Dec. 7, 2023

(54) METHOD FOR OPERATING AN ELECTRIC VEHICLE WITH FEEDBACK

(71) Applicant: AUDI AG, Ingolstadt (DE)

(72) Inventor: Shane CANNON, Beilngries (DE)

(21) Appl. No.: 18/330,204

(22) Filed: Jun. 6, 2023

(30) Foreign Application Priority Data
Jun. 7, 2022 (DE) 102022114228.0

(51) Int. Cl. B60W 50/16

(52) U.S. Cl. CPC B60W 50/16; B60W 2510/081

(57) ABSTRACT

A method for operating an electric vehicle, in which an electronic control of the electric vehicle receives a torque demand during operation of the electric vehicle and generates a control signal based on the torque demand, and the electric motor provides a torque that accelerates the electric vehicle based on the control signal, as well as an electronic control for an electric vehicle and an electric vehicle.

### BACKGROUND

### Technical Field

The disclosure relates to a method for operating an electric vehicle, in which an electronic control of the electric vehicle receives a torque demand during the operation of the electric vehicle and generates a control signal based on the torque demand, and the electric motor provides a torque that accelerates the electric vehicle based on the control signal. Moreover, the disclosure relates to an electronic control for an electric vehicle and an electric vehicle.

### Description of the Related Art

Operating methods of the mentioned kind in various configurations are part of the prior art and serve for making an electric motor of an electric vehicle provide a torque depending on a torque demand to accelerate the electric vehicle. An electronic control of the electric vehicle generates a control signal depending on the torque demand. The electric motor provides the torque, depending on the control signal so generated.

Electric motors as internal combustion engines can provide large torques to accelerate the electric vehicle. Consequently, a strongly increasing torque demand may result in loss of adhesion of the driving wheels of the electric vehicle.

This unwanted consequence is prevented by JP 2008 167 623 A which discloses a method for operating an electric vehicle in which a strongly increasing torque demand is superimposed with a waveform in order to counteract an impending loss of adhesion of the driving wheels of the electric vehicle.

So-called hybrid vehicles comprise an internal combustion engine in addition to an electric motor. Accordingly, a hybrid vehicle provides multiple operating modes. US 2014 0228168 A1 discloses a method for operating a (plugin) hybrid vehicle. A hybrid vehicle whose traction battery can be charged not only by way of recuperation, but also by way of an external charging station, is known as a plugin hybrid vehicle. In the method, an electric motor and an internal combustion engine of the hybrid vehicle are each operated by themselves, together, or not at all. The driver of the hybrid vehicle selects a corresponding operating mode of the hybrid vehicle.

One feature of an electric vehicle is that the electric vehicle gives the driver of the electric vehicle little or no haptically and/or auditory perceptible feedback as to an operating state of the electric motor during the driving. The little or no feedback goes hand in hand with less driver control over the torque provided by the electric motor.

This unwanted consequence is dealt with by DE 10 2011 000 175 A1, which discloses a method for operating an electric vehicle in which a vibrator situated in the steering wheel or seat of the electric vehicle generates vibrations and/or a noise generator generates noises corresponding to an operation of the electric motor of the electric vehicle.

However, the vibrations and/or noises produced in this way can hardly simulate realistically a feedback of an internal combustion engine, so that the driver's control over the provided torque remains deficient.

Therefore, embodiments of the disclosure provide a method for operating an electric vehicle which improves control of a torque provided by an electric motor of the electric vehicle and increases acceptance of the electric vehicle. Further, embodiments of the disclosure provide an electronic control for an electric vehicle and an electric vehicle.

### BRIEF SUMMARY

One embodiment of the disclosure is a method for operating an electric vehicle, in which an electronic control of the electric vehicle receives a torque demand during the operation of the electric vehicle and generates a control signal based on the torque demand and the electric motor provides a torque that accelerates the electric vehicle based on the control signal. The electronic control provides a multiphase alternating voltage based on the control signal and applies the multiphase alternating voltage to the electric motor.

According to the disclosure, the electronic control determines superimposed pulses and the control signal contains the superimposed pulses. The superimposed pulses produce a control signal fluctuating in time, resulting in a corresponding fluctuation in time of the torque provided by the electric motor. The fluctuating torque causes a vibrating of the electric motor. The superimposed pulses can be defined by a curve shape, such as a sine oscillation, a triangle oscillation, a sawtooth oscillation, a square oscillation and/or a superpositioning of the mentioned elementary curve shapes.

The vibrating electric motor can quite realistically simulate a naturally vibrating internal combustion engine and give the driver of the electric vehicle a readily perceivable and usable haptically perceivable feedback as to the operating condition of the electric motor. Thanks to the feedback, the driver has better control over the torque provided by the electric motor and the driver's acceptance of the electric vehicle is increased.

It is noted that the fluctuating torque furthermore counteracts a sudden and unrecognized loss of adhesion of the drive wheels of the electric vehicle in a limit range of acceleration of the electric vehicle, thus improving the control of the electric vehicle and increasing the driving safety of the electric vehicle.

Preferably, the electronic control determines an amplitude of the superimposed pulses depending on a travel speed of the vehicle. In particular, the amplitude can be determined greater with increasing travel speed, i.e., the faster the electric vehicle travels, the more strongly the electric motor vibrates. The travel speed corresponds to the linear velocity of the electric vehicle relative to the ground, an angular velocity of the wheels of the electric vehicle, or an angular velocity of the rotor of the electric motor.

Further preferably, the electronic control determines a frequency of the superimposed pulses based on the torque or on a torque to be provided. In particular, the frequency can be determined higher with increasing torque, i.e., the more the electric vehicle is accelerated, the faster the electric motor vibrates. The electronic control can use a predictive model to determine a torque to be provided in future and determine the frequency based on a predicted torque which is to be provided.

Advantageously, the electronic control simulates by way of the superimposed pulses so determined a vibrating of a given internal combustion engine. Every internal combustion engine has a characteristic vibration profile, i.e., a particular dependency of the vibration on a travel speed and/or an acceleration of the electric vehicle. The electronic control can be adapted to determine a curve shape, an amplitude and/or a frequency of the superimposed pulses corresponding to the vibration profile of the given internal combustion engine.

In particular, an activation element of the electric vehicle sends the torque demand to the electronic control and the electronic control receives the torque demand from the activation element. For example, a gas pedal of an electric passenger vehicle or a handlebar of an electric motorcycle can send the torque demand as the activation element.

Ideally, an artificial neural network of the electronic control determines the superimposed pulses. The artificial neural network can be trained to determine the superimposed pulses in real time, such that usefulness and/or driving pleasure is maximized.

The electronic control can control the electric motor with a torque limitation and/or with a delay relative to the torque demand. The torque limitation increases the driving safety of the electric vehicle. The delay is a time gap between the torque demand and the control signal based on the torque demand. The delay further improves the driver's control over the torque.

In one embodiment, the electronic control controls an infotainment system of the electric vehicle and the infotainment system puts out noise based on the superimposed pulses. The noise can simulate operating noise of an internal combustion engine and thereby provide an auditory perceptible feedback. The additional auditory perceptible feedback further improves the driver's control over the torque so provided and can moreover increase the driving pleasure.

The electronic control can determine and superimpose the superimposed pulses based on a type of operation of the electric vehicle and/or based on the driver's wishes. If the electric vehicle has the driving modes “comfort,” “dynamic” or “sporty,” the electronic control can generate the superimposed pulses in the operating modes “dynamic” and “sporty,” but not in the operating mode “comfort”. Apart from this, the infotainment system of the electric vehicle can allow the driver to configure the superimposed pulses and/or noise generated by the electronic control. The configuration can be done conveniently by way of predefined vibration patterns such as “soft,” “V12” or “single cylinder.”

In particular, the configuration can allow the driver to switch the superimposed pulses on and off as desired. The feedback superimposed pulses are optional additions to the operating modes of the electric vehicle.

Another embodiment of the disclosure is an electronic control for an electric vehicle. The electronic control is adapted to receive a torque demand and to provide a multiphase alternating voltage for an electric motor of the electric vehicle depending on the received torque demand.

According to the disclosure, the electronic control is adapted to operate the electric vehicle together with an electric motor of the electric vehicle to carry out a method according to an embodiment of the disclosure. The electronic control is adapted to determine superimposed pulses and to generate a control signal based on the torque demand, containing the superimposed pulses. The determined superimposed pulses bring about vibrating of the electric motor. In this way, the electronic control improves the driver's control over the torque provided by the electric motor and the electronic control increases the driver's acceptance of the electric vehicle.

Yet another embodiment of the disclosure is an electric vehicle, comprising an electric motor and an electronic control connected to the electric motor in order to control the electric motor. Such electric vehicles are very widespread and will become even more so. Accordingly, there exist and will exist many possible applications for the disclosure.

According to the disclosure, the electronic control is an electronic control according to one embodiment of the disclosure. Thanks to the electronic control according to the disclosure, the electric vehicle allows the driver a better control over the torque provided by the electric motor and will enjoy a greater acceptance by the driver.

One major advantage of the method according to the disclosure is that the driver of an electric vehicle obtains feedback as to the operating condition of the electric motor of the electric vehicle. Thanks to the feedback, the driver can better control the torque provided by the electric motor and will have a greater acceptance of the electric vehicle. A further advantage is that the loss of adhesion of driving wheels of the electric vehicle is counteracted, which makes possible great driving safety of the electric vehicle especially in a limit range of acceleration of the electric vehicle.

### BRIEF DESCRIPTION OF THE SEVERAL VIEWS OF THE DRAWINGS

The disclosure is shown schematically with the aid of one embodiment in the drawings and shall be described further with reference to the drawings.

FIG. 1 shows in a block diagram, an electric vehicle according to one embodiment of the disclosure;

FIG. 2 shows two function graphs of superimposed pulses, which are determined by an electronic control of the electric vehicle shown in FIG. 1;

FIG. 3 shows two function graphs of superimposed pulses, which are determined by an electronic control of the electric vehicle shown in FIG. 1;

FIG. 4 shows a function graph of a control signal which is generated by the electronic control of the electric vehicle shown in FIG. 1;

FIG. 5 shows a function graph of a control signal which is generated by the electronic control of the electric vehicle shown in FIG. 1.

### DETAILED DESCRIPTION

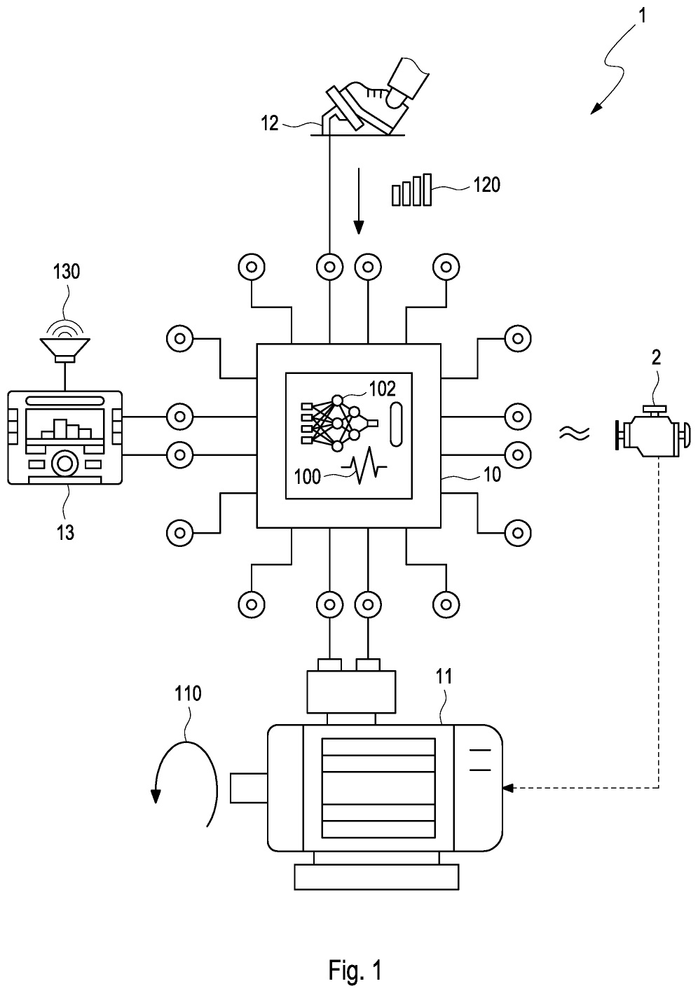

FIG. 1 shows in a block diagram an electric vehicle 1 according to one embodiment of the disclosure. The electric vehicle 1 can be configured as an electric passenger car or an electric motorcycle and it comprises an electric motor 11 and an electronic control 10 according to one embodiment of the disclosure, connected to the electric motor 11, for control of the electric motor 11. Moreover, the electric vehicle 1 can have an activation element 12, such as a pedal as shown or a handlebar regulator, and/or an infotainment system 13.

The electronic control 10 is suited to the electric vehicle 1 and is designed to operate the electric vehicle 1 together with the electric motor 11 of the electric vehicle 1 in order to carry out a method according to an embodiment of the disclosure.

The activation element 12 of the electric vehicle 1 can send a torque demand 120 to the electronic control 10.

During the operation of the electric vehicle 1, the electronic control 10 of the electric vehicle 1 receives the torque demand 120, in particular from the activation element 12, and generates a control signal 100 based on the torque demand 120. The electric motor 11 provides a torque 110 based on the control signal 100 to accelerate the electric vehicle 1.

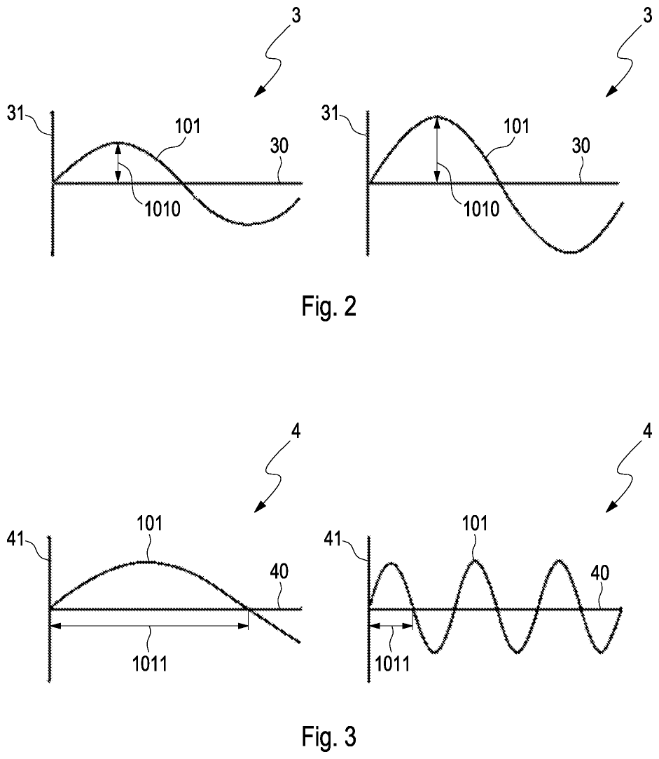

The electronic control 10 determines superimposed pulses 101. FIGS. 2 and 3 show function graphs of superimposed pulses 101 determined by an electronic control of the electric vehicle 1 shown in FIG. 1. The generated control signal 100 contains the superimposed pulses 101. Advantageously, an artificial neural network 102 of the electronic control 10 determines the superimposed pulses 101.

The electronic control 10 can determine an amplitude 1010 of the superimposed pulses 101 depending on the travel speed 14 (see FIG. 5) of the electric vehicle 1.

FIG. 2 shows two function graphs 3 of superimposed pulses 101, having a sine shape merely as an example and not being limited to this. Each function graph 3 has an abscissa 30, by which the time is plotted, and an ordinate 31, by which a superimposed pulse value is plotted. The superimposed pulses 101 shown in the left function graph 3 have a lower amplitude 1010 than the superimposed pulses 101 shown in the right function graph 3.

Alternatively or additionally, the electronic control 10 can determine a frequency 1011 of the superimposed pulses 101 depending on the provided torque 110 or a torque 110 which is to be provided.

FIG. 3 shows two function graphs 4 of superimposed pulses 101, having a sine shape merely as an example and not being limited to this. Each function graph 4 has an abscissa 40, by which the time is plotted, and an ordinate 41, by which a superimposed pulse value is plotted. The superimposed pulses 101 shown in the left function graph 4 have a higher frequency 1011, i.e., a longer period, than the superimposed pulses 101 shown in the right function graph 4.

It is also possible, alternatively or additionally, for the electronic control 10 to simulate a vibrating of a given internal combustion engine 2 by way of the superimposed pulses 101.

Ideally, the electronic control 10 controls the electric motor 11 with a torque limitation and/or with a delay relative to the torque demand 120.

Furthermore, the electronic control 10 can control the infotainment system 13 of the electric vehicle 1. The controlled infotainment system 13 can then put out a sound or noise 130 dependent on the superimposed pulses 101 so determined.

In particular, the electronic control 10 determines and superimposes the superimposed pulses 101 depending on the operating mode of the electric vehicle 1 and/or depending on the driver's wishes.

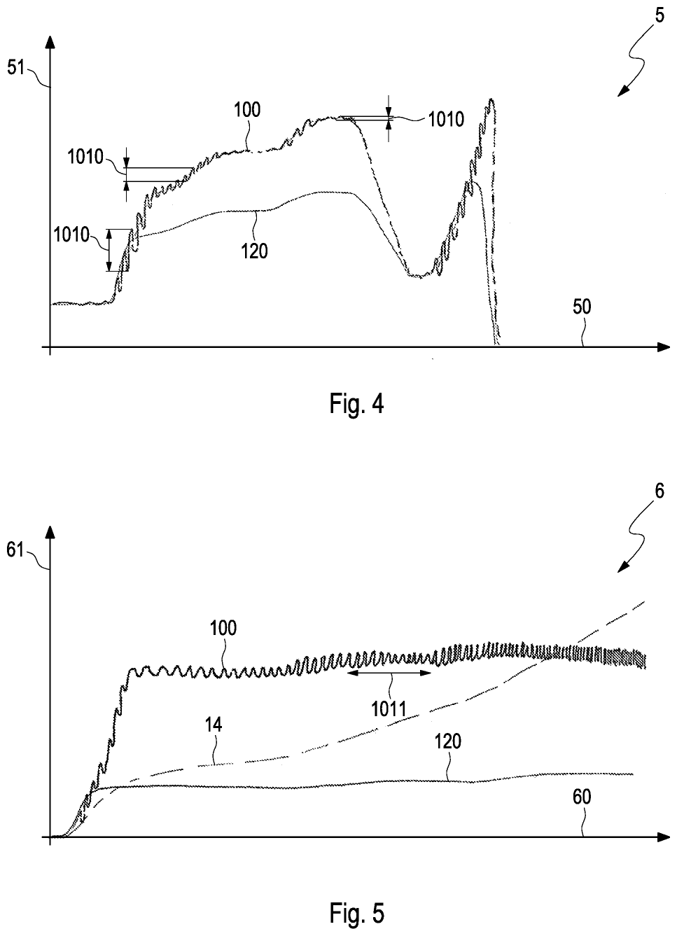

FIG. 4 shows a function graph 5 of a control signal 100 which is generated by the electronic control 10 of the electric vehicle 1 shown in FIG. 1. The function graph 5 has an abscissa 50, by which the time is plotted, and an ordinate 51, by which values of the torque demand 120 and values of the control signal 100 are plotted. The superimposed pulses of the control signal 100 have a greater amplitude 1010 as the torque demand 120 increases. For example, three different amplitudes 1010 are represented at three different places on the time curve of the torque demand 120.

FIG. 5 shows a function graph 6 of a control signal 100 which is generated by the electronic control 10 of the electric vehicle 1 shown in FIG. 1. The function graph 6 has an abscissa 60, by which the time is plotted, and an ordinate 61, by which values of the torque demand 120, values of the travel speed 14, and values of the control signal 100 are plotted. The torque demand 120 at first increases and then remains constant, while the travel speed 14 of the electric vehicle increases gradually at constant torque demand 120. The superimposed pulses of the control signal 100 have a frequency 1011 increasing with the increasing travel speed 14, i.e., a decreasing period.

German patent application no. 102022114228.0, filed Jun. 7, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating an electric vehicle, the method comprising:
receiving, by an electronic control of the electric vehicle, a torque demand during operation of the electric vehicle;
generating, by the electronic control of the electric vehicle, a control signal based on the torque demand;
providing, by an electric motor of the electric vehicle, a torque that accelerates the electric vehicle based on the control signal; and
determining, by the electronic control of the electric vehicle, superimposed pulses, wherein the control signal contains the superimposed pulses.

2. The method according to claim 1, further comprising:
determining, by the electronic control of the electric vehicle, an amplitude of the superimposed pulses based on a travel speed of the electric vehicle.

3. The method according to claim 2, further comprising:
determining, by the electronic control of the electric vehicle, a frequency of the superimposed pulses based on the torque.

4. The method according to claim 1, further comprising:
simulating, by the electronic control of the electric vehicle, vibrations of a given internal combustion engine based on the superimposed pulses.

5. The method according to claim 1, further comprising:
sending, by an activation element of the electric vehicle, the torque demand to the electronic control, wherein the electronic control receives the torque demand from the activation element.

6. The method according to claim 1, wherein an artificial neural network of the electronic control determines the superimposed pulses.

7. The method according to claim 1, further comprising:
controlling, by the electronic control of the electric vehicle, the electric motor with a torque limitation or a delay relative to the torque demand.

8. The method according to one of claim 1, further comprising:
controlling, by the electronic control of the electric vehicle, an infotainment system of the electric vehicle to output sound based on the superimposed pulses.

9. The method according to claim 1, wherein the electronic control determines and superimposes the superimposed pulses based on a type of operation of the electric vehicle or input from a driver of the electric vehicle.

10. An electronic control for an electric vehicle, the electronic control comprising:
at least one processor; and
at least one memory storing instructions that, when executed by the at least one processor, cause the electronic control to:
receive a torque demand during operation of the electric vehicle,
generate a control signal based on the torque demand, wherein the control signal causes an electric motor of the electric vehicle to provide a torque that accelerates the electric vehicle; and
determine superimposed pulses, wherein the control signal contains the superimposed pulses.

11. The electronic control according to claim 10, further comprising:
an electric vehicle connected to the electric motor,
wherein the electronic control, in operation, controls the electric motor.
